(19) United States
(12) Patent Application Publication
(10) Pub. No.: US 2006/0200528 A1
(43) Pub. Date: Sep. 7, 2006

(54) Method and system for processing data messages

(76) Inventor: Krishna Pathiyal, Waterloo (CA)

Correspondence Address: DANAMRAJ & YOUST, P.C., PREMIER PLACE, SUITE 1450, 5910 NORTH CENTRAL EXPRESSWAY, DALLAS, TX, 75206, US

(21) Appl. No.: 11/339,693

(22) Filed: Jan. 25, 2006

Related U.S. Application Data
(60) Provisional application No. 60/646,807, filed on Jan. 25, 2005.
(60) Provisional application No. 60/646,863, filed on Jan. 25, 2005.
(60) Provisional application No. 60/646,864, filed on Jan. 25, 2005.
(60) Provisional application No. 60/646,868, filed on Jan. 25, 2005.
(60) Provisional application No. 60/650,802, filed on Feb. 8, 2005.
(60) Provisional application No. 60/650,838, filed on Feb. 8, 2005.
(60) Provisional application No. 60/661,111, filed on Mar. 11, 2005.

(51) Int. Cl. G06F 15/16

(52) U.S. Cl. 709/206

(57) ABSTRACT

A system (10) for processing data messages includes a mail server (16), data messaging server (20) and a mobile communications device (22). The mail server (16) is operable to receive a first data message (100) transmitted over a public network (24), the first data message (100) having a plurality of data fields and decode the first data message (100). The data messaging server (20) is operable to exclude at least one data field of the plurality of data fields, encode a second data message (108) derived from the first data message (100) without the at least one excluded data field and transmit the second data message (108) over a first wireless data channel. The mobile communications device (22) is operable to receive the second data message (108), decode the second data message (108) and display the second data message (108) without displaying the at least one excluded data field.

### PRIORITY UNDER 35 U.S.C. §119(e) & 37 C.F.R. §1.78

This nonprovisional application claims priority based upon the prior U.S. provisional patent application No. 60/646,807, filed Jan. 25, 2006, application No. 60/646,863, filed Jan. 25, 2006, application No. 60/646,864, filed Jan. 25, 2006, application No. 60/646,868, filed Jan. 25, 2006, application No. 60/650,802, filed Feb. 8, 2006, application No. 60/650,838, filed Feb. 8, 2006 and application No. 60/661,111, filed Mar. 11, 2006, each of which is hereby incorporated by reference.

### TECHNICAL FIELD

The present disclosure relates, in general, to wireless communications between networked computers and mobile communication devices capable of supporting wireless data services and, in particular, to a method and system for processing data messages including email messages and communication messages.

### BACKGROUND

Mobile communications devices supporting data services over a radio interface provide access to messaging services, such as email and Multimedia Message Service (MMS). While data messages carried over a land line system typically do not consume a large quantity of bandwidth in relation to the available capacity, radio access networks have limited radio resources. As such, wireless carriers desire to utilize available resources as efficiently as possible to serve as many customers as possible with maximum quality of service. Likewise, consumers desire to utilize network resources as efficiently as possible in order to minimize cost.

Data message formats as described by various standards, such as RFC 821 and RFC 822, often comprise a plurality of data fields each having a tag and a value, for example a recipient field comprises a tag (To:) and a value (an internet email address). It has been found, however, that such a field structure may comprises tags and associated values that are nonessential. Therefore, it would be beneficial to provide a modified version of the field structure for data messages that are processed by a radio access network that does not include nonessential information to make more efficient use of radio resources.

### BRIEF DESCRIPTION OF THE DRAWINGS

For a more complete understanding of the features and advantages of the present methods and systems, reference is now made to the detailed description along with the accompanying figures in which corresponding numerals in the different figures refer to corresponding parts and in which:

FIG. 1 depicts an exemplary network environment including a wireless packet data service network wherein an embodiment of the present method may be practiced;

FIG. 2 depicts a block diagram of a mobile communications device according to one embodiment of the present disclosure;

FIG. 3 is a message flow diagram depicting the communication path of a data message wherein certain data fields that include nonessential information are excluded;

FIG. 4 is a message flow diagram depicting the communication path of a data message wherein certain data fields that include nonessential information are not included;

FIGS. 5A-5B depict an email message and a communication message formatted according to a compressed message format;

FIGS. 6A-6B are flow diagrams showing the procedural steps associated with processing email messages and communication messages according to various embodiments of the present disclosure;

FIGS. 7A-7C are email messages and communication messages derived from the email messages according to various embodiments of the present disclosure;

FIGS. 8A-8B depict communication messages that are created on and processed by a mobile communications device according to various embodiments of the present disclosure;

FIG. 9 depicts a message event list displayed on a mobile communications device according to the present disclosure; and

FIGS. 10A-10B depict an email message and a calendering message formatted according to a compressed message format.

### DETAILED DESCRIPTION

While various embodiments of the present methods and systems are discussed in detail below, it should be appreciated that the present disclosure provides many applicable inventive concepts which can be embodied in a wide variety of specific contexts. The specific embodiments discussed herein are merely illustrative of specific ways to make and use the systems and perform the methods, and do not delimit the scope of the present disclosure.

In one aspect, the present disclosure is directed to method for processing data messages. The method includes receiving a first data message transmitted over a public network, the first data message having a plurality of data fields, decoding the first data message, processing the first data message to exclude at least one data field of the plurality of data fields, encoding a second data message derived from the first data message without the at least one excluded data field and transmitting the second data message over a first wireless data channel.

In one embodiment, the first data message may be an email message that has a recipient field, a sender field, a subject field and a message field. In this embodiment, the second data message may be a communication message that has a recipient field, a sender field and a message field but not having a subject field. Alternatively, the second data message may be a calendering message.

In another embodiment, the step of processing the first data message to exclude at least one data field of the plurality of data fields involves excluding a subject field from the plurality of data fields that comprises a recipient field, a sender field, the subject field and a message field. In this embodiment, profile settings may be used to determine whether the step of processing of the first data message should exclude the at least one data field. In addition, this embodiment may include relocating the value of the subject field from the first data message into the message field of the second data message.

In a further embodiment, the step of transmitting the second data message over the public network and a relay network may occur prior to the step of transmitting the second data message over the first wireless data channel.

In addition to transmitting the second data message over the first wireless data channel, the method may include sending the first data message to a mailbox associated with a recipient of the first data message. The method may also include receiving the second data message and decoding the second data message. In this case, the second data message may be displayed without displaying the at least one excluded data field. Likewise, the second data message may be displayed in a message event list without displaying the at least one excluded data field.

In this embodiment, the method may further include encoding a third data message that is responsive to the second data message, the third data message including the same data fields as the second data message and transmitting the third data message over a second wireless data channel. Thereafter, the method may include receiving the third data message, decoding the third data message, processing the third data message including adding the at least one data field that was excluded from the first data message, encoding a fourth data message derived from the third data message including the at least one added data field and transmitting the fourth data message over the public network.

In another aspect, the present disclosure is directed to system for processing data messages that includes a mail server, a data messaging server and a mobile communications device. The mail server is operable to receive a first data message transmitted over a public network, the first data message having a plurality of data fields, decode the first data message and notify the data messaging server of the arrival of the first data message. The data messaging server is operable to obtain information decoded from the first data message excluding at least one data field of the plurality of data fields, encode a second data message derived from the first data message without the at least one excluded data field and transmit the second data message over a first wireless data channel. The mobile communications device is operable to conduct data services over a radio interface and receive the second data message.

In a further aspect, the present disclosure is directed to a data messaging server having a processor that is operable to obtain information decoded from a first data message excluding at least one data field of a plurality of data fields of the first data message, encode a second data message derived from the first data message without the at least one excluded data field and transmit the second data message over a first wireless data channel.

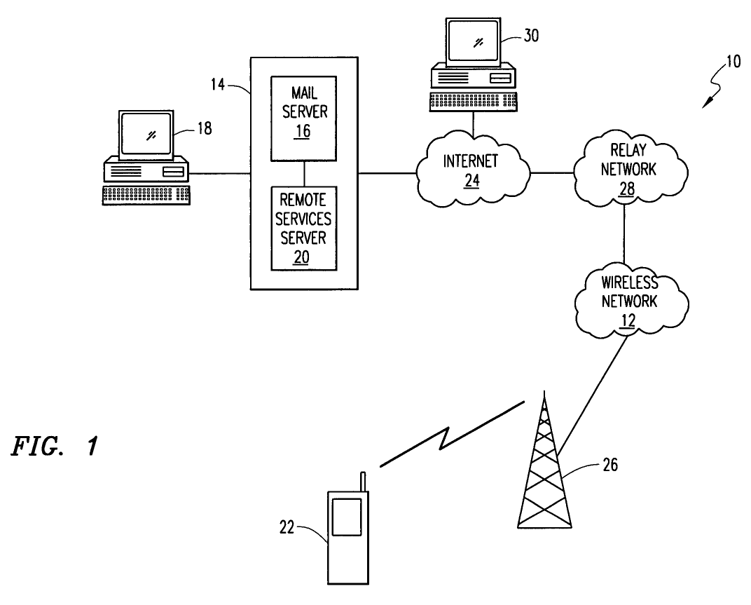

Referring now to the drawings, and more particularly to FIG. 1, depicted therein is an exemplary network environment 10 including one or more wireless packet data service networks depicted as wireless network 12. An enterprise network 14 is operable to serve a plurality of corporate users. Enterprise network 14 may be a packet-switched network, may include one or more geographic sites, may be organized as a local area network (LAN), a wide area network (WAN), a metropolitan area network (MAN) or the like and may include one or more firewalls to protect the information from outside access. Any number of application servers such as mail server 16 may be disposed as part of the enterprise network 14 and are operable to provide or effectuate a host of internal and external services such as Internet access, corporate data access, information management and the like as well as certain continually operable data services such as email, video mail, messaging, calendaring, scheduling and the like.

A diverse array of personal information appliances such as desktop computers, laptop computers, palmtop computers or the like, one of which is depicted as appliance 18, may be operably networked to one or more of the application servers with respect to the services supported in the enterprise network 14. Additionally, a data messaging server referred to in FIG. 1 as remote services server 20 may be disposed as part of enterprise network 14 for enabling a corporate user to access or effectuate certain services from a remote location using a suitable mobile communications device (MCD) 22. Even though the data messaging server is depicted as residing within enterprise network 14, it should be understood by those skilled in the art that the data messaging server could alternatively reside within a network of an Internet Service Provider (ISP) or within a desktop computer in communication with enterprise network 14 or in communication with a network of an ISP.

A secure communication link with end-to-end encryption may be established that is mediated through an external wide area network, i.e., a public packet-switched network such as the Internet 24, as well as the wireless network 12 operable with MCD 22 via suitable wireless network infrastructure that includes a base transceiver station 26. In the illustrated embodiment, a trusted relay network 28 is disposed between the Internet 24 and the infrastructure of wireless network 12. In certain embodiments, however, relay network 28 could be a part of wireless network 12. In addition, any number of personal information appliances such as desktop computers, laptop computers, palmtop computers or the like, one of which is depicted as appliance 30, may be operable to communicate with one another and with enterprise network 14 via the Internet 24. By way of example, when mail server 16 receives a data message addressed to the user of appliance 18 from the user of appliance 30, mail server 16 upon receiving the data message over the Internet 24 may send the data message to appliance 18 and to remote services server 20 which in turn sends the data message to relay network 28. Relay network 28 upon receipt of the received data message can then send the data message to MCD 22 over an interface compatible with wireless network 12.

For purposes of the present disclosure, MCD 22 may be a data-enabled handheld device capable of receiving and sending messages, web browsing, interfacing with corporate application servers and the like. Profile settings for MCD 22 may be set by receiving profile settings over the air from a network system. Alternatively, MCD 22 may receive profile settings and otherwise communicate directly with appliance 18 over a cable, such as a Universal Bus Cable (USB), or via a short-range wireless connection, such as Bluetooth.

Wireless network 12 may be implemented in any known or heretofore unknown mobile communications technologies and network protocols, as long as a packet-switched data service is available therein for transmitting packetized information. For instance, wireless network 12 may be comprised of a General Packet Radio Service (GPRS) network that provides a packet radio access for mobile devices using the cellular infrastructure of a Global System for Mobile Communications (GSM) based carrier network. In other implementations, wireless network 12 may comprise an Enhanced Data Rates for GSM Evolution (EDGE) network, an Integrated Digital Enhanced Network (IDEN), a Code Division Multiple Access (CDMA) network, a Universal Mobile Telecommunications System (UMTS) network, any 3rd Generation (3G) network or the like.

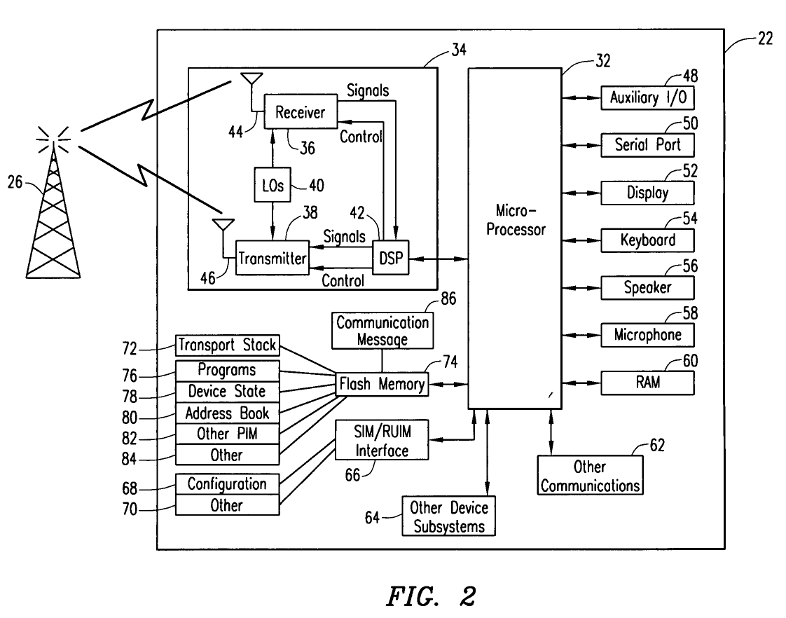

FIG. 2 depicts a block diagram of a mobile communications device that is capable of supporting data messaging services over a radio interface and that is generally designated 22. It will be recognized by those skilled in the art upon reference hereto that although an embodiment of MCD 22 may comprise an arrangement similar to one shown in FIG. 2, there can be any number of variations and modifications, in hardware, software or firmware, with respect to the various modules depicted. Accordingly, the arrangement of FIG. 2 should be taken as illustrative rather than limiting with respect to the embodiments of the present disclosure. A microprocessor 32 providing for the overall control of MCD 22 is operably coupled to a communication subsystem 34 which includes a receiver 36 and a transmitter 38 as well as associated components such as one or more local oscillator (LO) modules 40 and a processing module such as a digital signal processor (DSP) 42. As will be apparent to those skilled in the field of communications, the particular design of the communication module 34 may be dependent upon the communications network with which the mobile device is intended to operate.

In one embodiment, the communication module 34 is operable with both voice and data communications. Regardless of the particular design, however, signals received by antenna 44 through base station 26 are provided to receiver 36, which may perform such common receiver functions as signal amplification, frequency down conversion, filtering, channel selection, analog-to-digital (A/D) conversion, and the like. Similarly, signals to be transmitted are processed, including modulation and encoding, for example, by DSP 42, and provided to transmitter 38 for digital-to-analog (D/A) conversion, frequency up conversion, filtering, amplification and transmission over the air-radio interface via antenna 46.

Microprocessor 32 also interfaces with further device subsystems such as auxiliary input/output (I/O) 48, serial port 50, display 52, keyboard 54, speaker 56, microphone 58, random access memory (RAM) 60, a short-range communications subsystem 62 and any other device subsystems generally labeled as reference numeral 64. To control access, a Subscriber Identity Module (SIM) or Removable user Identity Module (RUIM) interface 66 is also provided in communication with the microprocessor 32. In one implementation, SIM/RUIM interface 66 is operable with a SIM/RUIM card having a number of key configurations 68 and other information 70 such as identification and subscriber-related data.

Operating system software and software associated with transport stack 72 may be embodied in a persistent storage module (i.e., non-volatile storage) such as flash memory 74. In one implementation, flash memory 74 may be segregated into different areas, e.g., storage areas for computer programs 76, device states 78, address book 80, other personal information manager (PIM) data 82 and other data storage areas generally labeled as reference numeral 84. Additionally, a communication message logic module 86 is provided for processing communication messages according to the teachings set forth herein.

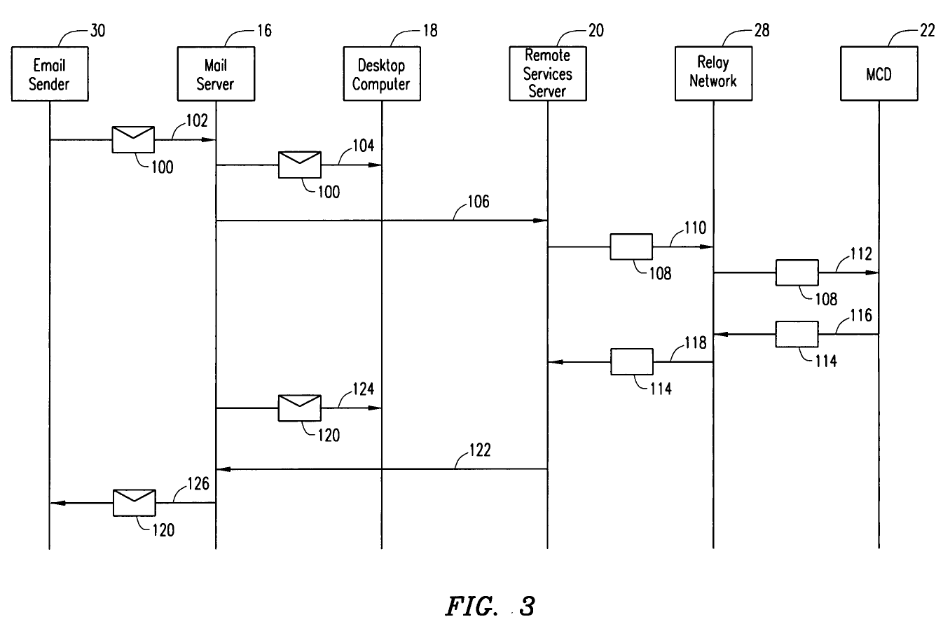

Referring next to FIG. 3, a message flow diagram depicts the communication path of a data message wherein certain data fields that include nonessential information are excluded. In this process, remote services server 20 is in communications with MCD 22 which is capable of supporting data messaging services over a radio interface. Both remote services server 20 and MCD 22 are operable to encode and decode, transmit and receive, and display data messages without predetermined fields. In addition, both remote services server 20 and MCD 22 may alter the operation of processing data messages upon determining from system profile settings that processing data messages without predetermined tags and values is desired.

In FIG. 3 and with reference to FIG. 1, the user of appliance 30 has sent an email message 100 to the user of appliance 18 who is also the user of MCD 22. Email message 100 comprising the following data fields: a recipients field including a recipient tag (To) and a recipient value (one or mare destination addresses), a sender field including a sender tag (From) and a sender value (the sender's address), a subject field including a subject tag (Subject) and a subject value (subject data) and a message field including message value (message data). Email message 100 is received by mail server 16 via communication path 102, which includes the Internet 24. Mail server 16 processes email message 100 including sending a copy of email message 100 to appliance 18 via communication path 104, which may include a wired or wireless communication link, decoding email message 100 and sending a notification of the arrival of email message 100 to remote services server 20 via communication path 106. In the illustrated embodiment, a message redirection program executing on remote services server 20 has previously registered to receive such notifications or advise syncs from the primary messaging program executing on mail server 16 using, for example, Microsoft® Messaging API (MAPI). Thereafter, such notifications are send from mail server 16 to remote services server 20 when a change to a mailbox takes place. As such, remote services server 20 monitors the activity of mail server 16 and is operable to produce a communication message 108 for ultimate delivery to a MCD associated with the mailbox of the recipient, in this case MCD 22. More specifically, after receiving the notification, remote services server 20 reads certain message fields of the decoded email message 100 and encodes a communication message 108 that is based upon email message 100 but does not include all of the data fields of email message 100.

For example, remote services server 20 may obtain information from the recipients field, the sender field and the message field of email message 100 but not obtain information from the subject field. Remote services server 20 then encodes communication message 108 which would comprise a recipient field, a sender field, and a message field including the message value or a portion thereof depending upon the filtering rules associated with MCD 22. Communication message 108, however, does not include a subject field as none was obtained by remote services server 20. As one alternative, if email message 100 did not include a message value, the subject value from email message 100 may be encoded in communication message 108 so that it is associated with the message value. As another alternative, remote services server 20 may encode communication message 108 without a message value. In this instance, the encoded communication message 108 would comprise a sender field, a recipient field and a subject field but no message field.

In any event, following the encoding, remote services server 20 transmits communication message 108 to relay network 28 via communication path 110 including the Internet 24 using, for example, a gateway messaging envelope packet and Transmission Control Protocol and Internet Protocol (TCP/IP protocol) or other suitable protocol including X.25, SDLC, ATM or the like. Relay network 28 would then interface communication message 108 to MCD 22 via communication path 112 including wireless network 12 and base station 26 employing, for example, User Datagram Protocol and Internet Protocol (UDP/IP protocol) or other suitable protocol including X.25, SDLC, ATM, ISDN or the like. As such, relay network 28 is able to couple distinct networks that do not share a common communication method by using a common routing envelop across the networks.

After receipt of communication message 108, MCD 22 is able to visually display information from communication message 108 in its message event list and when the message is opened. In the present example, MCD 22 will not, however, visually display any information relating to the subject tag or subject value of any communication message in its message event list or when the message is opened. In the message event list, the displayed information may include, for example, a message icon, the time communication message 108 was received and sender identification. When communication message 108 is opened, the displayed information will include the sender tag and value, the recipient tag and value and any message value. Information from the subject field is excluded, since the subject field was never received by MCD 22. As should be understood by those skilled in the art, the information in communication message 108 is derived from information of email message 100. As such, other message attributes from email message 100 may also be included in communication message 108 including, but not limited to, the message's sensitivity and urgency, the total size of the message, the number of and names associated with any attachments of the message, carbon copy information, date, time and location information or the like.

If the user of MCD 22 decides to response to the received communication message 108 by, for example, executing a command to reply, to reply to all or to forward the communication message 108, MCD 22 encodes a response communication message 114. In the present example wherein communication message 108 included a recipient field, a sender field and a message field, response communication message 114 would similarly include these data fields. Alternatively, if communication message 108 included a recipient field, a sender field and a subject field, response communication message 114 would similarly include these data fields.

Once encoded, communication message 114 would then be transmitted to the relay network 28 via communication path 116 including base station 26 and wireless network 12. Relay network 28 would then interface communication message 114 to remote services server 20 via communication path 118 including the Internet 24. Remote services server 20 then decodes communication message 114 and sends information from communication message 114 to mail server 16 via communication path 122. Preferably, mail server 16 then encodes an email message 120 that includes all the data fields of communication message 114 and the additional missing data field of, for example, the subject field which was associated with email message 100 and stored by mail server 16. Mail server 16 then forwards a copy of email message 120 to the user's desktop, in this case appliance 18 via communication path 124, which may include a wired or wireless communication link, and forwards a copy of email message 120 to the intended recipient, in this case the user of appliance 30, via communication path 126 including the Internet 24. In this manner, if system requirements were such that MCD 22 is required to process data messages without a subject fields, this processing can be performed seamlessly to the original sender/response recipient using the systems and methods disclosed herein.

In one alternative approach, email message 100 may be sent to remote servers server 20 in its entirety. In this approach, remote servers server 20 decodes and processes email message 100 to remove the desired field, such as the subject field, then encodes communication message 108 for transmission to relay network 28. As another alternative approach, email message 100 may be sent to remote servers server 20 and to relay network 28 in its entirety. In this approach, relay network decodes and processes email message 100 to remove the desired field, such as the subject field, then encodes communication message 108 for transmission to MCD 22. In either of these approaches, the component that processes email message 100 to remove or exclude the desired field would also be responsible for reattaching the missing field to the reply or forward message.

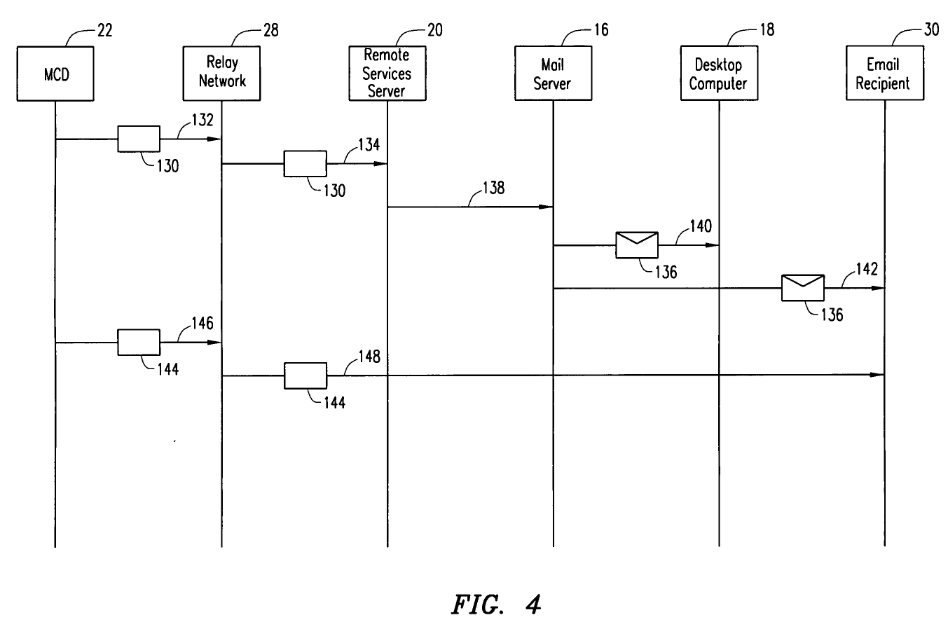

Referring next to FIG. 4, a message flow diagram depicts the communication path of a data message wherein certain data fields that include nonessential information are not included. MCD 22 encodes a communication message 130 including a recipient field, a sender field and a message field. Communication message 130 would then be transmitted to relay network 28 via communication path 132 including base station 26 and wireless network 12. When communication message 130 is received by relay network 28, the subject field is excluded since the subject field was never included by MCD 22. Relay network 28 would then interface communication message 130 to remote services server 20 via communication path 134 including the Internet 24. Remote services server 20 then decodes communication message 130 and sends information from communication message 130 to mail server 16 via communication path 138. Preferably, mail server 16 encodes an email message 136 that includes the missing data fields of communication message 130. In certain embodiments, if system requirements were such that MCD 22 is required to process communication messages without subject tags and values, mail server 16 may obtain a subject value that is associated with the user's account and encode the email message with that subject value in association with the subject tag. In other embodiments, if no subject value is associated with the user's account, the encoded email message may include a subject tag with no subject value or may use a first set of characters or a first line of the message value from the communication message as the subject value in the encoded email message. Mail server 16 then forwards a copy of email message 136 to the user's desktop, in this case appliance 18 via communication path 140, which may include a wired or wireless communication link, and forwards a copy of email message 136 to the intended recipient, in this case the user of appliance 30, via communication path 142 including the Internet 24. Alternatively, either relay network 28 or remote services server 20 could decode communication message 130 and encode email message 136 that includes the missing data fields of communication message 130 in a manner similar to that described above.

Continuing to refer to FIG. 4, certain communications from MCD 22 to an intended recipient can be accomplished without the use of remote services server 20. For example, MCD 22 may encode a communication message 144 including a recipient tag and recipient value, a sender tag and sender value and a message value. Communication message 144 would then be transmitted to relay network 28 via communication path 146 including base station 26 and wireless network 12. In this case, relay network 28 would then interface communication message 144 directly to the intended recipient, such as the user of appliance 30 via communication path 148 including the Internet. Alternatively, relay network 28 could decode communication message 144 and encode an email message (not shown) that includes one or more of the data fields not included in communication message 144 in a manner similar to that described above. Once relay network 28 has encoded the email message, relay network 28 would then interface the email message directly to the intended recipient, such as the user of appliance 30, via communication path 148 including the Internet.

As discussed above, the present systems and methods are used to restrict the communication of certain data fields of a communication message within a wireless messaging service. In general, the wireless messaging system components, produce, process and exchange communication messages instead of email messages. The basic difference between communication messages and email messages is that communication messages are formatted so as to exclude certain data fields such as the subject field used in the example above.

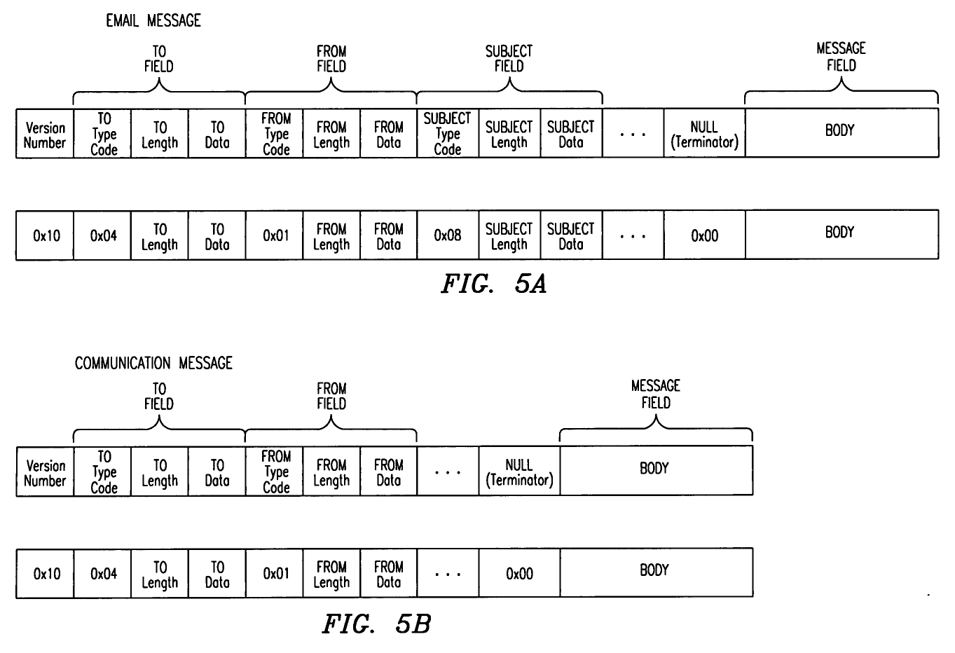

Referring next to FIGS. 5A-5B, data messages are typically formatted according to a compressed message format, for example, the header may use the RFC 822 standard and the body may use the RFC 1521 MIME format, with each header and body being communicated over a channel including a wireless channel in the compressed format. FIG. 5A depicts an exemplary compressed format of an email message while FIG. 5B depicts an exemplary compressed format of a communication message according to the present messaging system. As shown, the email message format has a recipient field depicted as a TO field, a sender field depicted as a FROM field, a SUBJECT field, a MESSAGE field, as well as other fields. In contrast, the communication message format has a recipient field depicted as a TO field, a sender field depicted as a FROM field, a MESSAGE field, as well as other fields. In the illustrated embodiment, the communication message is formatted so as to exclude a SUBJECT field.

Both the email message and the communication message are shown with generic information (the upper depiction of each message) as well as with additional lower-level data (the lower depiction of each message). Using type-length encoding, three elements are utilized for the communication of each field. Specifically, each field includes a type element, a length element and a data element. The type element contains a type code which identifies the type of data contained in the associated field. The length element contains a value which identifies the length of the data contained in the associated data element. In the SUBJECT field of the email message, for example, the type code has a value of “0x08” (hexadecimal value of 8) which indicates that the subject data element will contain subject data. The format of the communication message, however, is defined to exclude any corresponding SUBJECT field, therefore there is no subject type element, no subject length element and no subject data element transferred in this type of communication message.

The user of MCD 22 can compose communication messages that have the format of the communication message depicted in FIG. 5B. When the user initiates the composition of a communication message, MCD 22 displays a TO input area and a MESSAGE input area for the user to input data. No input area for inputting SUBJECT data, however, is provided in its display. The communication message is created based on the inputted data and includes a TO field, a FROM field and a MESSAGE field but no SUBJECT field is included within the communication message. That is, the communication message is formatted so as to exclude any subject type elements, subject length elements and subject data elements.

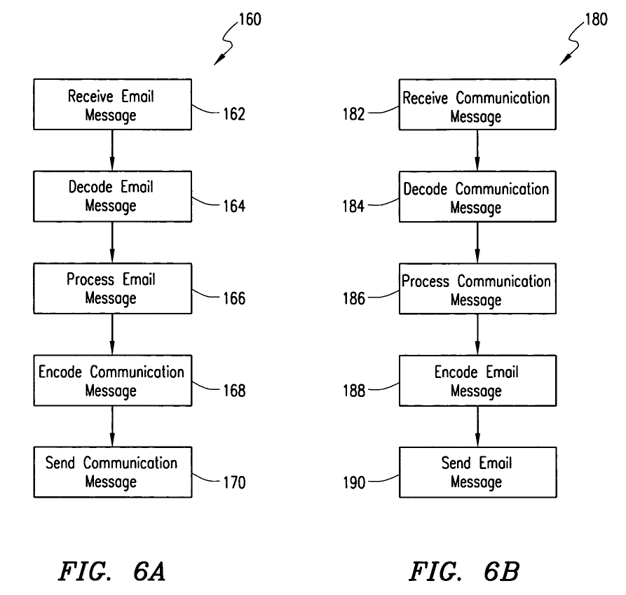

Referring now to FIGS. 6A-6B, flow diagrams show the procedural steps associated with processing email messages and communication messages according to embodiments of the present disclosure. In process 160 of FIG. 6A, an email message is received (block 162) from, for example, the user of appliance 30. Upon receiving the email message, the email message is decoded (block 164). The decoded email message would comprise a recipient field, a sender field, a subject field and a message field. The email message may now be processed (block 166) to remove or excluded the nonessential fields such as the subject field. A communication message is then encoded (block 168) that is derived from the email message including a recipient field, a sender field and a message field but no subject field. The communication message is then transmitted to, for example, MCD 22 (block 170). As noted above, if the email message did not include a message value, the subject value of the email message could be encoded as the message value in the communication message. Alternatively, the communication message could be encoded with a subject field but no message field. In this instance, the encoded communication message would comprise a sender tag and value, a recipient tag and value, and a subject tag and value.

In process 180 of FIG. 6B, a communication message is received (block 182) from, for example, MCD 22. Upon receiving the communication message, the communication message is decoded (block 184). The decoded communication message would comprise a recipient field, a sender field and a message field. The communication message is then processed (block 186) to preferably add information into the missing field, such as the subject field. For example, if the communication message was derived from an email message that was originally encoded to include a subject value, that subject information may be stored in association with a user's account and a message identification such that when a reply or forward communication message derived from the email message is processed, the subject information can be reinstated. In this case, the original subject value is encoded back onto an email message (block 188) such that the email message will include a recipient field, a sender field, a subject field and a message field. The email message is then transmitted (block 190) to the intended recipient, such as the user of appliance 30.

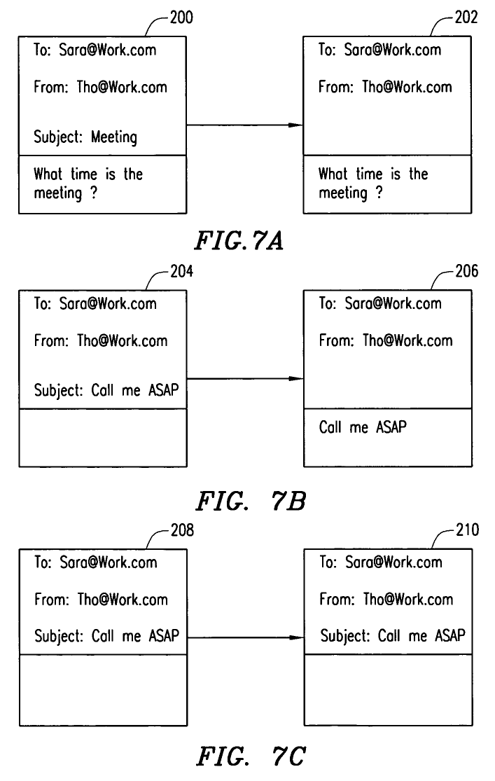

Referring to FIGS. 7A-7C, email messages and communication messages derived from the email messages according to various embodiments of the present disclosure are depicted. In FIG. 7A, an email message 200 comprises the data fields of recipient, sender, subject and message, such as sara@work.com, tho@work.com, meeting, and what time is the meeting?, respectively. In this embodiment, email message 200 is decoded and processed to generate a communication message 202 based upon email message 200 so that communication message 202 does not include the subject field. Communication message 202 comprises the data fields of recipient, sender and message, such as sara@work.com, tho@work.com and what time is the meeting?, respectively. It should be noted, however, by those skilled in the art that the subject value of email message 200 could alternatively be placed in the message field, such as in the first line of the message field. Communication message 202 may now be wirelessly transmitted over a radio channel to MCD 22 for display on a screen of MCD 22.

In FIG. 7B, an email message 204 comprises the data fields of recipient, sender and subject, such as sara@work.com, tho@work.com, and call me ASAP, respectively. In this embodiment, email message 204 is decoded and processed to generate a communication message 206 based upon email message 204 so that communication message 206 does not include the subject field. Communication message 206 comprises the data fields of recipient, sender and message, such as sara@work.com, tho@work.com and call me ASAP, respectively. In this particular embodiment, the subject field is not included in communication message 206, but the value associated with the subject field of email message 204 has been moved to the message field of communication message 206. Communication message 206 may now be wirelessly transmitted over a radio channel to MCD 22 for display on a screen of MCD 22.

In FIG. 7C, an email message 208 comprises the data fields of recipient, sender and subject, such as sara@work.com, tho@work.com, and call me ASAP, respectively. In this embodiment, email message 208 is decoded and processed to generate a communication message 210 based upon email message 208 so that communication message 210 does not include the message field. Communication message 210 comprises the data fields of recipient, sender and subject, such as sara@work.com, tho@work.com and call me ASAP, respectively. In this particular embodiment, the message field is not included in communication message 210, with the value associated with the subject field of email message 208 remaining in the subject field of communication message 210. In addition, it should be understood by those skilled in the art that communication message logic module 86 of MCD 22 may also be operative to similarly manage email messages by reading the data fields and constructing a communication message comprising only the desired data fields and then interfacing the communication message to an intended recipient.

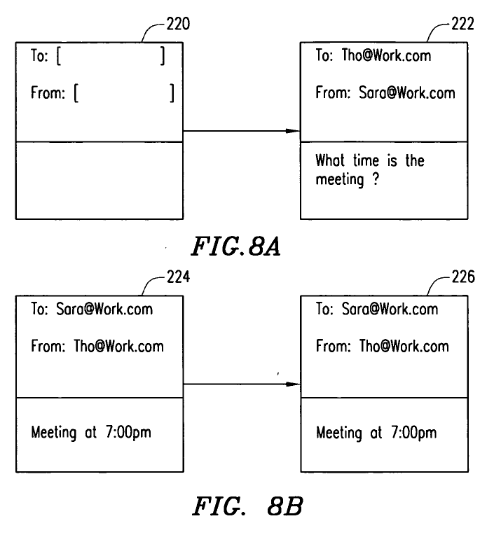

Referring now to FIGS. 8A-8B, communication messages that are created on and processed by a MCD according to various embodiments of the present disclosure are depicted. In FIG. 8A, a new message template 220 that would be displayed by MCD 22 includes a selectable recipient object for adding recipient address information in a location associated with the recipient tag, a selectable or auto filled sender object for including a sender value in a location associated with the sender tag, and a message box for entering message content. To create a communication message 222, the user inputs the desired information in the appropriate fields such as tho@work.com as the recipient value, sara@work.com as the sender value and what time is the meeting? as the message contents. MCD 22 then encodes and transmits communication message 222 to the intended recipient via, for example, relay network 28 and remote services server 20. As illustrated, MCD 22 does not present the user with a message template 220 including a subject field and does not encode the communication message 222 with a subject field. Even though only the basic data fields are identified in FIG. 8A, those of skill in the art will recognize that new message template 220 and communication message 222 may also support other header fields and associated body content, such as urgency indicators, date, time, location, CC information, multimedia content and the like.

In FIG. 8B, a communication message 224 comprising the fields sara@work.com as the recipient value, tho@work.com as the sender value and meeting at 7:00 pm as the message contents has been received by MCD 22. MCD 22 decodes communication message 224 so that the contents of communication message 224 can be displayed to the user in a message display template 226. Message display template 226 comprises the fields sara@work.com as the recipient value, tho@work.com as the sender value and meeting at 7:00 pm as the message contents. Communication message 224 does not include a subject field. Likewise, message display template 226 does not display a subject tag or subject value. Even though only the basic data fields are identified in FIG. 8B, those of skill in the art will recognize that communication message 224 and message display template 226 may also support other header fields and associated body content, such as urgency indicators, date, time, location, CC information, multimedia content and the like.

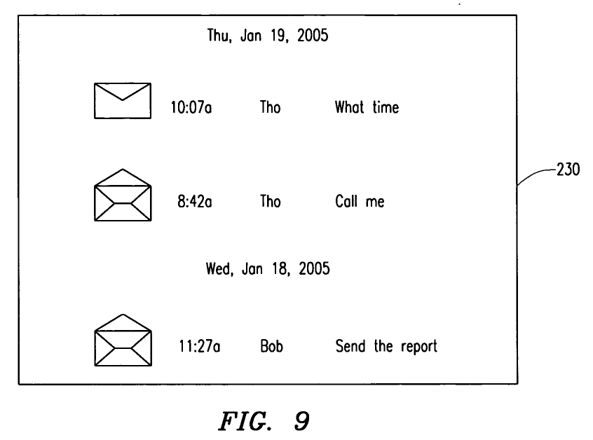

Referring now to FIG. 9, a message event list 230 is being displayed on the screen of MCD 22. MCD 22 displays selectable objects on the screen wherein the selectable object comprises labels identifying tags and associated values, such as the date and time a message was received or sent, the sender or the recipient, and a concatenated version of the message value from either received or sent communication messages. MCD 22 displays a predetermined number of communication messages that is dependent on the size of the screen. The user of MCD 22 can scroll through message event list 230, using an input device, such as a scroll wheel or a navigation key, and as the user scrolls past the predetermined number displayed, MCD 22 replaces the displayed content with later or earlier dated communication messages. In addition, message event list 230 may include unique identifiers to identify which communication messages were sent and received, for example using a different graphical icon or color coding. In the present example wherein communication messages do not include a subject field, message event list 230 does not display subject data and does not have any subject fields.

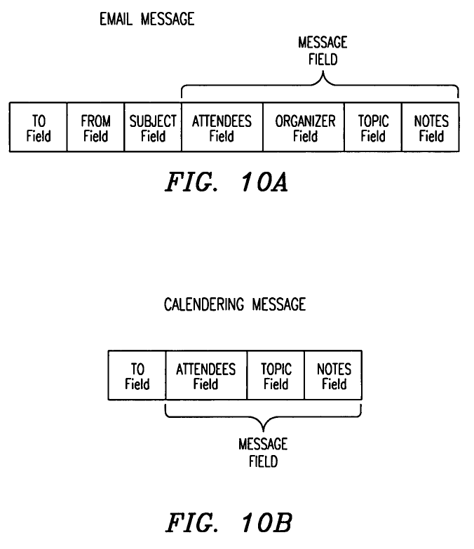

Referring next to FIGS. 10A-10B, therein is depicted the relevant parts of an email message and a calendering message formatted according to a compressed message format. FIG. 10A depicts the relevant parts of an exemplary compressed format of an email message while FIG. 10B depicts the relevant parts of an exemplary compressed format of a calendering message according to the present messaging system. The email message for a calendar meeting invitation includes a recipients field containing one or more destination addresses, a sender field containing the sender's address, a subject field containing subject data, a message field containing message data and including a calendaring data attachment. The calendaring data attachment includes the proposed attendees of the meeting in an attendees field, the organizer of the meeting in an organizer field, the topic of the meeting, start time and end time of the meeting, the location of the meeting and the urgency of the meeting in the topic field, and any other information relating to the meeting in a notes field.

The email message is sent from the sender's computer, such as appliance 30, to the intended recipients, such as the user of appliance 18 via mail server 16. Remote services server 20 monitors the activity of mail server 16 and is operable to produce a calendaring message based on the email message for ultimate delivery to MCD 22. The calendaring message contains information from the email message that is formatted according to a compressed calendar message format. The calendaring message has a recipients field containing one or more destination addresses, a message field containing message data from the calendaring data attachment including the proposed attendees of the meeting in an attendees field, the topic of the meeting, start time and end time of the meeting, the location of the meeting and the urgency of the meeting in the topic field, and any other information relating to the meeting in a notes field. In the illustrated embodiment, no subject field and no sender field are included as part of the compressed formatting of the calendaring message. Thus, the constructed calendaring message is formatted according to a compressed message format, such as a composite RFC 822 header and MIME body in a compressed format, so as to exclude subject and sender fields. The revised calendar data attachment of the disclosed calendaring message is formatted in accordance with a compressed iCal formatting wherein no organizer field is included. Thus, the revised calendar data attachment is formatted according to CiCal so as to exclude the organizer field.

Remote services server 20 communicates the calendaring message to relay network 28 via the Internet 24, which in turn communicates the calendaring message through the wireless network 12 for receipt by MCD 22. Thus, MCD 22 does not receive the original email message but instead receives the calendaring message as described. After receipt of the calendaring message, MCD 22 is able to visually display information from the calendaring message in its message event list and when the message is opened. MCD 22 does not visually display any sender, subject or organizer information of any calendaring message in the message event list or when the message is opened. For example, in the message event list, the displayed information may include a message icon and the time the message was received. When the message is opened, the displayed information includes the recipients of the meeting request, the attendees of the meeting and the topic of the meeting along with any notes, however, the sender, subject or organizer information is excluded as it was never received by MCD 22.

While this disclosure has described methods and systems with reference to illustrative embodiments, this description is not intended to be construed in a limiting sense. Various modifications and combinations of the illustrative embodiments as well as other embodiments, will be apparent to persons skilled in the art upon reference to the description. It is, therefore, intended that the appended claims encompass any such modifications or embodiments.

What is claimed is:

1. A method for processing data messages comprising:
receiving a first data message transmitted over a public network, the first data message having a plurality of data fields;
decoding the first data message;
processing the first data message to exclude at least one data field of the plurality of data fields;
encoding a second data message derived from the first data message without the at least one excluded data field; and
transmitting the second data message over a first wireless data channel.

2. The method as recited in claim 1 wherein the step of receiving a first data message over a public network further comprises receiving an email message over the public network and wherein the step of transmitting the second data message over a first wireless data channel further comprises transmitting a communication message over the first wireless data channel.

3. The method as recited in claim 2 wherein the step of receiving an email message further comprises receiving an email message having a recipient field, a sender field, a subject field and a message field.

4. The method as recited in claim 3 wherein the step of transmitting a communication message further comprises transmitting a communication message having a recipient field, a sender field and a message field but not having a subject field.

5. The method as recited in claim 1 wherein the step of receiving a first data message over a public network further comprises receiving an email message over the public network and wherein the step of transmitting the second data message over a first wireless data channel further comprises transmitting a calendering message over the first wireless data channel.

6. The method as recited in claim 1 wherein the step of receiving a first data message over a public network further comprises receiving the first data message using a TCP/IP protocol and wherein the step of transmitting the second data message over a first wireless data channel further comprises transmitting the second data message using a UDP/IP protocol.

7. The method as recited in claim 1 wherein the step of processing the first data message to exclude at least one data field of the plurality of data fields further comprises excluding a subject field from the plurality of data fields that comprises a recipient field, a sender field, the subject field and a message field.

8. The method as recited in claim 7 wherein the step of encoding a second data message further comprises including a value of the subject field from the first data message in a message field of the second data message.

9. The method as recited in claim 1 further comprising the step of determining from profile settings that the processing of the first data message should exclude the at least one data field.

10. The method as recited in claim 1 wherein the step of transmitting the second data message over a first wireless data channel further comprises transmitting the second data message over a radio interface.

11. The method as recited in claim 1 further comprises the step of transmitting the second data message over the public network and a relay network prior to the step of transmitting the second data message over the first wireless data channel.

12. The method as recited in claim 1 further comprises the step of sending the first data message to a mailbox associated with a recipient of the first data message.

13. The method as recited in claim 1 further comprising the steps of receiving the second data message and decoding the second data message.

14. The method as recited in claim 13 further comprising the step of displaying the second data message without displaying the at least one excluded data field.

15. The method as recited in claim 13 further comprising the step of displaying the second data message in a message event list without displaying the at least one excluded data field.

16. The method as recited in claim 13 further comprising the steps of encoding a third data message that is responsive to the second data message, the third data message including the same data fields as the second data message and transmitting the third data message over a second wireless data channel.

17. The method as recited in claim 16 further comprising the steps of:
receiving the third data message;
decoding the third data message;
processing the third data message including adding the at least one data field excluded from the first data message;
encoding a fourth data message derived from the third data message including the at least one added data field; and
transmitting the fourth data message over the public network.

18. A system for processing data messages comprising:
a mail server operable to receive a first data message transmitted over a public network, the first data message having a plurality of data fields, decode the first data message and send a notification regarding the first data message;
a data messaging server operable to receive the notification, obtain information decoded from the first data message excluding at least one data field of the plurality of data fields, encode a second data message derived from the first data message without the at least one excluded data field and transmit the second data message over a first wireless data channel; and
a mobile communications device operable to conduct data services over a radio interface and receive the second data message.

19. The system as recited in claim 18 wherein the mail server is operable to receive an email message over the public network and wherein the data messaging server is operable to transmit a communication message over the first wireless data channel.

20. The system as recited in claim 19 wherein the email message further comprises a recipient field, a sender field, a subject field and a message field.

21. The system as recited in claim 20 wherein the communication message further comprises a recipient field, a sender field and a message field but does not comprise a subject field.

22. The system as recited in claim 18 wherein the mail server is operable to receive an email message over the public network and wherein the data messaging server is operable to transmit a calendering message over the first wireless data channel.

23. The system as recited in claim 18 wherein the data messaging server is operable to exclude a subject field from the plurality of data fields that comprises a recipient field, a sender field, the subject field and a message field.

24. The system as recited in claim 23 wherein the data messaging server is operable to encode the second data message to include a value of the subject field from the first data message in a message field of the second data message.

25. The system as recited in claim 18 wherein the data messaging server is operable to determine from profile settings that the at least one data field should be excluded from the first data message.

26. The system as recited in claim 18 wherein the first wireless data channel further comprises a radio interface.

27. The system as recited in claim 18 wherein the data messaging server is operable to transmit the second data message over the public network and a relay network prior to transmitting the second data message over the first wireless data channel.

28. The system as recited in claim 18 wherein the mail server is operable to send the first data message to a mailbox associated with a recipient of the first data message.

29. The system as recited in claim 18 wherein the mobile communications device is operable to decode the second data message.

30. The system as recited in claim 29 wherein the mobile communications device is operable to display the second data message without displaying the at least one excluded data field.

31. The system as recited in claim 29 wherein the mobile communications device is operable to display the second data message in a message event list without displaying the at least one excluded data field.

32. The system as recited in claim 29 wherein the mobile communications device is operable to encode a third data message that is responsive to the second data message, the third data message including the same data fields as the second data message and transmit the third data message over a second wireless data channel.

33. The system as recited in claim 32 wherein the data messaging server is operable to receive the third data message and decode the third data message and wherein the mail server is operable to encode a fourth data message derived from the third data message including adding the at least one excluded data field from the first data message and transmit the fourth data message over the public network.

34. A data messaging server for processing data messages comprising:
a processor operable to obtain information decoded from a first data message excluding at least one data field of a plurality of data fields of the first data message, encode a second data message derived from the first data message without the at least one excluded data field and transmit the second data message over a first wireless data channel.

35. The data messaging server as recited in claim 34 wherein the processor is operable obtain information decoded from an email message and transmit a communication message over the first wireless data channel.

36. The data messaging server as recited in claim 35 wherein the email message further comprises a recipient field, a sender field, a subject field and a message field.

37. The data messaging server as recited in claim 36 wherein the communication message further comprises a recipient field, a sender field and a message field but does not comprise a subject field.

38. The data messaging server as recited in claim 34 wherein the processor is operable obtain information decoded from an email message and transmit a calendering message over the first wireless data channel.

39. The data messaging server as recited in claim 34 wherein the processor is operable to exclude a subject field from the plurality of data fields that comprises a recipient field, a sender field, the subject field and a message field.

40. The data messaging server as recited in claim 39 wherein the processor is operable to encode the second data message to include a value of the subject field from the first data message in a message field of the second data message.

41. The data messaging server as recited in claim 34 wherein the processor is operable to determine from profile settings that the at least one data field should be excluded from the first data message.

42. The data messaging server as recited in claim 34 wherein the first wireless data channel further comprises a radio interface.

43. The data messaging server as recited in claim 34 wherein the processor is operable to transmit the second data message over the public network and a relay network prior to transmitting the second data message over the first wireless data channel.

44. A system for processing data messages comprising:
means for receiving a first data message transmitted over a public network, the first data message having a plurality of data fields;
means for decoding the first data message;
means for processing the first data message to exclude at least one data field of the plurality of data fields;
means for encoding a second data message derived from the first data message without the at least one excluded data field; and
means for transmitting the second data message over a first wireless data channel.
